(19) United States
(12) Patent Application Publication
(10) Pub. No.: US 2022/0339058 A1
(43) Pub. Date: Oct. 27, 2022

(54) WEARABLE DYNAMIC MASSAGE DEVICE AND ASSEMBLY

(71) Applicant: roura Inc., Seattle, WA (US)

(72) Inventors: Vlasta Schutzenhofer, Seattle, WA (US); Abigail Szabo, Seattle, WA (US); Folatomi Alli-Balogun, Philadelphia, PA (US); Malini Rao, Bangalore (IN); Audrey Walsh, Washington, DC (US); Xinyue Wei, Philadelphia, PA (US)

(21) Appl. No.: 17/698,655

(22) Filed: Mar. 18, 2022

Related U.S. Application Data
(60) Provisional application No. 63/179,809, filed on Apr. 26, 2021.

(51) Int. Cl. A61H 9/00

(52) U.S. Cl. CPC A61H 9/0092; A61H 2201/1628; A61H 2201/165; A61H 2201/0207; A61H 2201/1238; A61H 2201/1207; A61H 2201/501; A61H 2201/1654; A61H 2201/5097; A61H 2201/0228; A61H 2205/083

(57) ABSTRACT

A massage device includes a body including a first layer defining an interior side, a second layer defining an exterior side, a heating assembly including a heating element disposed adjacent to the interior side of the body, and a massage assembly including a pump and an inflatable bladder coupled to the pump. The massage assembly is coupled to the body and arranged to provide a dynamic massage. A power supply is electrically coupled to the heating assembly and the massage assembly.

### FIELD OF DISCLOSURE

The present disclosure is directed to an assembly for soothing pain, and in particular, a wearable device and assembly using massage to soothe abdominal pain.

### BACKGROUND

A number of different medical conditions may cause pain and discomfort in the lower back and lower abdominal areas. One of these conditions, dysmenorrhea (also known as period pain or cramps), whether primary or secondary, is the most common gynecological condition. In fact, an estimated 20% of all menstruators suffer from menstrual cramping so severe that they cannot participate in daily activities. Oftentimes, dysmenorrhea forces people to miss school or work. Even though dysmenorrhea periodically debilitates a significant number of menstruators, significant research in alleviating dysmenorrhea is lacking. Doctors routinely suggest treating dysmenorrhea with heating pads or over-the-counter medication. However, these solutions do not always provide sufficient comfort to every person experiencing such pain, and often renders the person experiencing pain inactive, and unable to carry on with daily activities.

### SUMMARY

According to an aspect of the present disclosure, a wearable dynamic massage device and assembly includes a massage assembly and/or a heating assembly to target and treat abdominal pain discreetly. While experiencing pain or discomfort in the lower back and/or lower abdominal areas due to dysmenorrhea, for example, a user may discreetly wear a wearable device, as disclosed herein, which heats and massages the area to provide additional comfort, and remain active.

In accordance with a first aspect of the present disclosure, a massage device may include a body having a first layer defining an interior side and a second layer defining an exterior side. A heating assembly may include a heating element disposed adjacent to the interior side of the body. A massage assembly may include a pump and an inflatable bladder coupled to the pump. The massage assembly may be coupled to the body and arranged to provide a dynamic massage. A power supply may be electrically couplable to the heating assembly and the massage assembly.

In accordance with a second aspect, a wearable massage device may include a body having first layer and a second layer coupled to the first layer. The body may be configured for placement on a person. A massage assembly may be at least partially disposed between the first and second layers of the body. The massage assembly may include a pump, a first inflatable bladder, and a second inflatable bladder. The pump may be selectively couplable with one or more of the first and second inflatable bladders to dynamically inflate the first and second inflatable bladders.

In accordance with a third aspect, a wearable massage device may include a body having an interior side arranged to engage a body part and an exterior side opposite the interior side. A massage assembly may be at least partially adjacent to the interior side of the body. The massage assembly may include a pump, a first inflatable bladder, and a second inflatable bladder. The pump may be selectively couplable with at least one of the first and second inflatable bladders to dynamically inflate the first and second inflatable bladders. The first and second inflatable bladders may expand outwardly from the interior side of the body when inflated.

In accordance with a fourth aspect, a wearable massage device may include a body having an interior side arranged to engage a body part and an exterior side opposite the interior side. A massage assembly may be at least partially adjacent to the interior side of the body and including. A heating assembly may include a heating element embedded in the body between the exterior side and the interior side. A control system may be operatively coupled to at least one of the massage assembly and heating assembly. The control system may include a processor and a memory communicatively coupled to the processor. The memory may store executable instructions that, when executed by the processor, cause the processor to receive, from a mobile device, via a wireless communication link between the wearable massage device and the mobile computing device, a signal including an indication of one or more operational parameters for controlling the wearable massage device, and control the wearable massage device based on the one or more operational parameters. The massage assembly may protrude outwardly from the interior side of the body when activated.

In further accordance with any one of the first, second, third, and fourth aspects, a wearable device and/or assembly may include any one or more of the following forms.

In one form, the bladder may be disposed on an interior side of the body.

In another form, the body may be configured for biasing against the bladder causing the bladder to expand away from the body when the bladder is inflated.

In some forms, the massage assembly may include a second bladder.

In one example, the second bladder may be coupled to the pump.

In these and other examples, the bladder may be coupled to a first solenoid valve.

In another example, the second bladder may be coupled to a second solenoid valve.

In some forms, the first and second solenoid valves may be coupled to the pump.

In some forms, the massage assembly may include a third bladder coupled to the first solenoid valve.

In some forms, a control system may be coupled to the massage assembly to selectively operate the first solenoid valve and the second solenoid valve to inflate one or more of the bladders.

In an alternative form, the control system may include a processor and a memory communicatively coupled to the processor.

In one form, the memory may store executable instructions that, when executed by the processor, may cause the processor to: receive data transmitted by a remote communication device; send a signal to one or more of the first and second solenoid valves to open, thereby inflating the one or more bladders based on the data received.

In one form, the control system may be coupled to the heating assembly.

In another form, the instructions, when executed by the processor, may cause the processor to control the heating assembly by activating the heating element of the heating assembly based on the data received.

In another form, the instructions, when executed by the processor, may cause the processor to control an inflation level of one or more of the bladders based on the one or more operational parameters.

In another example, the instructions, when executed by the processor, cause the processor to control a speed of inflation of the one or more bladders based on the one or more operational parameters.

In one form, the instructions, when executed by the processor, may cause the processor to control one or more of the inflation level of one or more of the bladders of the massage device and the speed of inflation of the one or more bladders by causing one or more of the first and second solenoid valves to open, thereby inflating the one or more bladders based on the one or more operational parameters.

In one example, the massage assembly is disposed between the first layer and the second layer of the body.

In some forms, a garment may define a pocket sized to receive the body.

In one form, the body may be insertable in the pocket of the garment.

In some examples, the heating element may include a polymer coating.

In these or other forms, the body may include a stiff material adjacent to the fabric layer and adjacent to the massage assembly.

In another form, the second fabric layer may be adjacent to an exterior side of the fabric layer.

In some examples, a third fabric layer may be adjacent to an interior side of the fabric layer.

In some forms, the body may include four separate layers of fabric.

In one example, the body may have a width of less than two inches.

In one form, the massage assembly may be arranged to provide a force in a range of approximately one pound to approximately five pounds.

In some forms, a flexible strap may be attached to a first side and a second side of the body.

In one example, the flexible strap may be arranged to form a loop with the body.

In these and other examples, the bladder of the massage assembly may be disposed on an interior side of the body to engage an abdominal region of a person.

In some forms, a heating assembly may include a heating element embedded in the body.

In an alternative form, the heating assembly may be operatively coupled to the control system.

In another form, the massage assembly may include a first solenoid valve coupled to the first inflatable bladder and a second solenoid valve coupled to the second inflatable bladder.

In another form, the instructions, when executed by the processor, may cause the processor to control a heat level of the heating element of the heating assembly by causing the heating assembly to activate based on the one or more operational parameters.

In one form, the heating element may be disposed in a first layer of a plurality of layers of the body.

In some forms, the plurality of layers may include an interior layer, the first layer adjacent to the interior layer, and a second layer adjacent to the first layer and including a rigid woven material.

In some examples, the mobile computing device may be a smart phone.

In these or other forms, the wireless communication link may be a short range wireless communication link.

In another form, the short range communication link may be Bluetooth, Wi-Fi, RFID, or NFC.

In some forms, the massage assembly may include a pump, a first inflatable bladder, and a second inflatable bladder, the pump being selectively couplable with one or more of the first and second inflatable bladders to dynamically inflate the first and second inflatable bladders.

In one form, the heating assembly may include a temperature sensor in communication with the processor.

### BRIEF DESCRIPTION OF THE DRAWINGS

FIG. 1 is a front perspective view of a first example wearable massage device featured on a body and assembled in accordance with the teachings of the present disclosure;

FIG. 2 is a back perspective view of the wearable device of FIG. 1;

FIG. 3 is a different perspective view of the wearable device of FIG. 1 and remote communication device;

FIG. 4 is a front, perspective, and partially transparent view of the wearable device of FIG. 3, showing an exterior portion of a dynamic massage assembly;

FIG. 5 is a side view of the wearable device of FIG. 3;

FIG. 6 is a back view of the wearable device of FIG. 3;

FIG. 7 is a back, partial perspective view of the wearable device of FIG. 3, showing a heating assembly assembled in accordance with the teachings of the present disclosure;

FIG. 8 is a back, perspective view of the wearable device of FIG. 4, showing an interior portion of the dynamic massage assembly;

FIG. 9 is a perspective view of the interior portion of the dynamic massage assembly of FIG. 8;

FIG. 10A is a top view of a bladder of the dynamic massage assembly assembled in accordance with the teachings of the present disclosure;

FIG. 10B is a side view of the bladder of FIG. 10A;

FIG. 10C is a front view of the bladder of FIG. 10A;

FIG. 10D is a perspective view of the bladder of FIG. 10A;

FIG. 11 is an example data plot showing maximum force on a body against width of a bladder;

FIG. 12 is an example data plot showing maximum achievable force against thickness of muscle or body fat;

FIG. 13 is an example force diagram of a bladder, showing air pressure and volume of a bladder against a force applied and a ground force;

FIG. 14 is an example force diagram of a bladder, showing air pressure and cross-sectional area of the bladder and against a force applied;

FIG. 15 is a front, perspective, and partially transparent view of the wearable device of FIG. 3, showing a control system and the remote communication device of FIG. 3;

FIG. 16 is a magnified, perspective view of the control system of FIG. 15;

FIG. 17 is a block diagram of a communication system to operate the wearable device;

FIG. 18 is a schematic diagram of a method of controlling the wearable device;

FIG. 19 is a back, perspective and partially exploded view of the wearable device of FIG. 3;

FIG. 20 is a cross-sectional view of a portion of the device of FIG. 3;

FIG. 21 is a front perspective view of a second example wearable dynamic massage device assembled in accordance with the teachings of the present disclosure;

FIG. 22 is a back perspective view of the wearable device of FIG. 21;

FIG. 23 is an example graphical user interface for controlling a wearable device assembled in accordance with the teachings of the present disclosure;

FIG. 24 is a front view of a third example dynamic massage assembly assembled in accordance with the teachings of the present disclosure;

FIG. 25 is a top, back, perspective view of the assembly of FIG. 24;

FIG. 26 is a partial perspective view of an insert of the assembly of FIG. 24;

FIG. 27 is a back perspective view of the insert of FIG. 26;

FIG. 28 is a front view of the insert of the assembly of FIG. 26;

FIG. 29 is a section view of the insert of FIG. 26, showing a first bladder in an inflated configuration and a second bladder in a deflated configuration;

FIG. 30A is a perspective view of a second example bladder of the insert of FIG. 26;

FIG. 30B is a cross-sectional view of the bladder of FIG. 30A;

FIG. 31 is a side view of an electronics module of the assembly of FIG. 24; and

FIG. 32 is a side view of internal components of the electronics module of FIG. 31.

### DETAILED DESCRIPTION

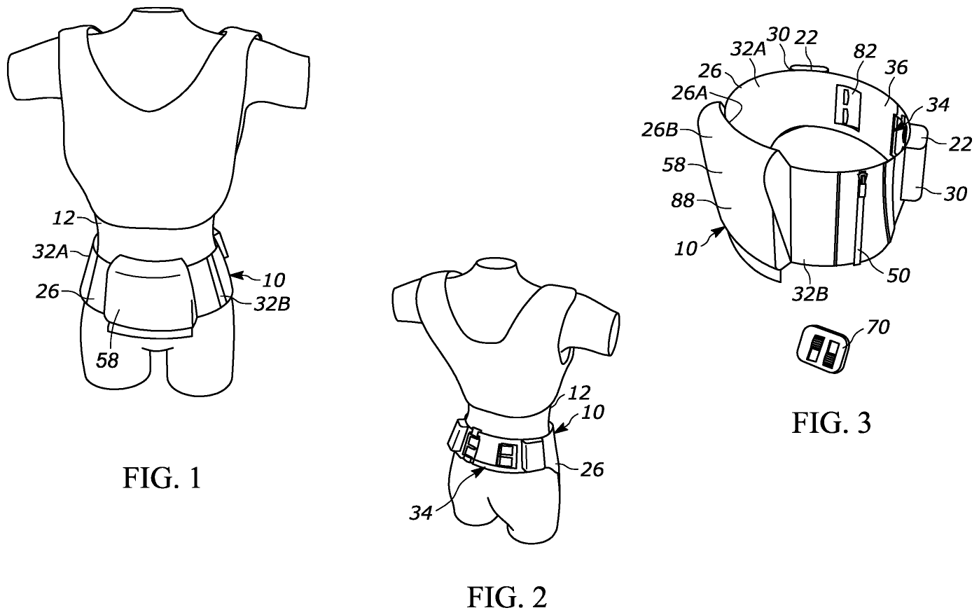

Generally speaking, a wearable dynamic massage device 10 is provided. The wearable device 10 in FIGS. 1 and 2 is shown attached to a representative body 12 of a user. The device 10 may be worn and controlled by a user to apply heat and an oscillating force to an abdominal region of the user's body 12. In particular, a body 58 or pouch of the device 10 is coupled heat and massage assemblies and arranged for placement against a front central area of a person's lower abdomen, between the navel and pubic bone, and is secured around the user's waist. However, in other examples, the device 10 may be arranged so that the heating and massage assemblies are arranged to treat other parts of a person's body, such as, for example, a lower back region, around certain joints, for example, wrists, knees, elbows, ankles, upper and lower back regions, shoulders, to treat muscle injuries, endometriosis, cramps, body pains, etc. Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

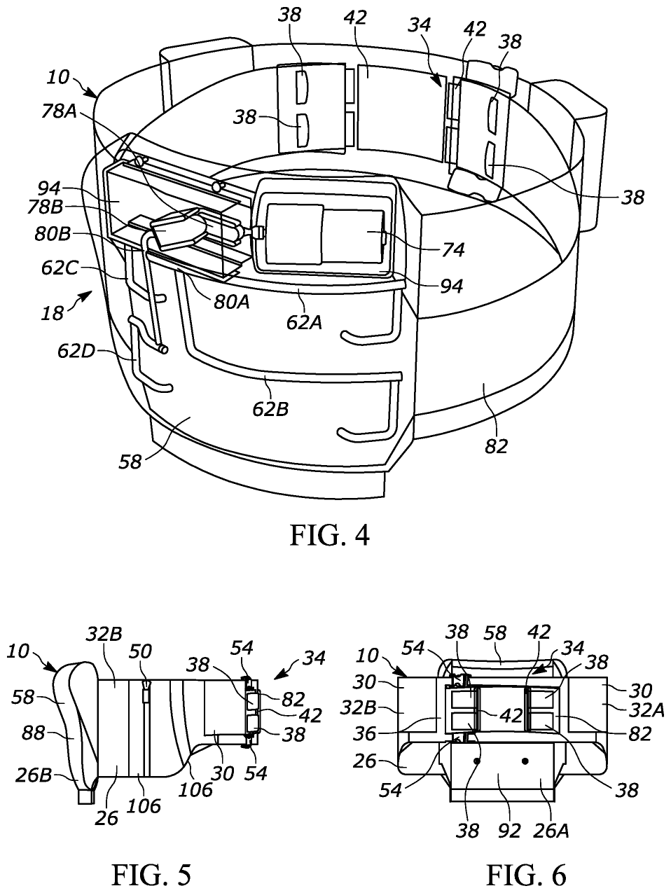

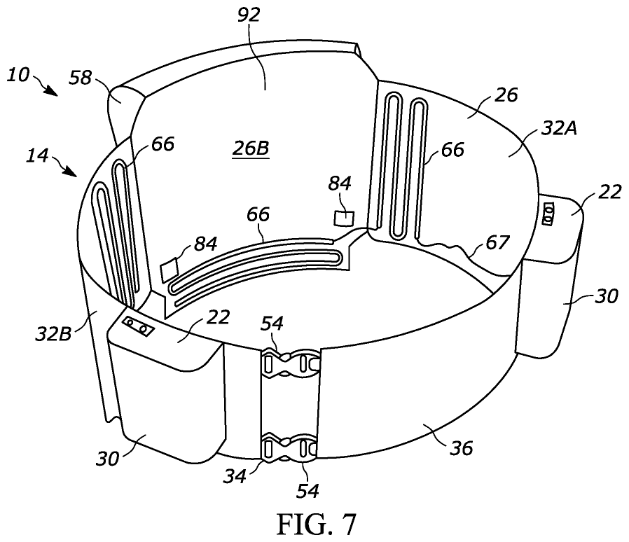

The body 58 of the massage device 10 includes a first layer 26A of material 11, such as fabric or flexible plastic, defining a first or exterior side 88, and a second layer 26B of material 13 defining a second or interior side 92. The body 58 is coupled to a heating assembly 14, as shown and described below with reference to FIG. 7, and a massage assembly 18, as shown and described below with reference to FIGS. 4 and 8-13. The heating assembly 14 includes a heating element 66 embedded in, or attached onto the body 58, and the massage assembly 18 includes a pump 94 and one or more inflatable bladders 46 coupled to the pump 94. A power supply 22 is electrically coupled to the heating assembly 14 and the massage assembly 18. The heating and massage assemblies 14, 18 are controlled using a remote control device 70, such as the handheld remote 70 in FIG. 3 that may clip on to the device 10 or user's clothing.

As shown in FIGS. 1 and 2, the body 58 is secured to the user by one or more straps 32 that extend from opposite sides of the body 58 to a closure assembly 34 at the back 36 of the device 10. An outer layer of fabric 26, which in this example includes the first and second layers 26A, 26B of the body 58, covers the structural band 82 and is separable from the internal components of the heating and massage assemblies 14, 18 for washing.

In FIGS. 2, 3, and 7 the power supply 22 of the device 10 is electrically coupled to both the heating and massage assemblies 14, 18, and includes one or more batteries 22. As shown in FIG. 7, electrical wiring embedded in one or more sides 32A, 32B of the device 10 couple the heating and massage assemblies 14, 18 to the batteries 22. In the illustrated example, each battery 22 is placed in a pocket 30 on one or more of the straps 32A, 32B of the device 10. In one example, the power supply 22 includes two rechargeable Lithium Polymer batteries 22. However, in other examples, the device 10 may include a different power supply and be positioned at different locations relative to the body 58. For example, the power supply 22 may include more than two batteries, may be one or more of a variety of battery chemistries, and may be placed at one or more of a variety of locations around the device 10. Other energy sources may also be used to power the device 10.

FIGS. 4-6 and 8 show an adjustable closure assembly 34 at the back portion 36 of the device 10 for placement at the center back of the user's body 12. The closure assembly 34 includes one or more buckle fasteners 54 and a tightening mechanism. The tightening mechanism includes four adjustable straps 38, two stacked vertically on each side 32A, 32B of the device 10, that extend through sliders or loops 42 in the band. The straps 38 may be pulled and fastened to the device 10 using hooks and loops for a tighter fit. In this example, the straps 38 can be tightened or loosened independently of each other to provide additional adjustability for the user. The multiple straps 38 are disposed at different heights on the wearable device 10 to allow the user to independently adjust the size of the device 10 for varying waist and hip measurements. This adjustability allows the wearable device 10 to accommodate many different body shapes in addition to different body sizes. Additionally, adjusting the straps 38 may also adjust the pressure of the massage assembly 18 against the person's body 12. The straps 38 may be a woven or nonwoven material such as but not limited to polyester, hook and loop, nylon, and cotton. In other examples, the number, type, material, and placement of adjustable straps may be varied. Additionally, a different method of adjusting the wearable device may be used such as, but not limited to, adjustable plastic snaps.

The closure device 34 may optionally include a zipper 50 positioned at one or more sides 32A, 32B of the device 10, as shown in FIG. 5. In some examples, the zipper 50 may be used instead of, or in addition to, one or more side-release buckles 54 of the closure assembly 34. In FIG. 6, side-release buckles 54 positioned at the back 36 and left side 32A of the device 10 are used to fasten the device 10 to the user's body 12. In other examples, the device 10 may be fastened around the user's body using methods such as, but not limited to, buttons, snaps, hook and loop, buckles, clasps, male and female locking components, hooks and eyes, or other locking devices that can be manually released to open and close the closure assembly 34. The closure assembly 34 may include one or more different closures and can also be placed in a variety of locations on the device 10. In the illustrated example, the closure assembly 34 is attached to the device 10 so that the device 10 is a unitary component. In other example arrangements of the device 10, the closure assembly 34 may be separately attached to the body 58 such that the device 10 can be separately used as a treatment pad rather than a wearable belt.

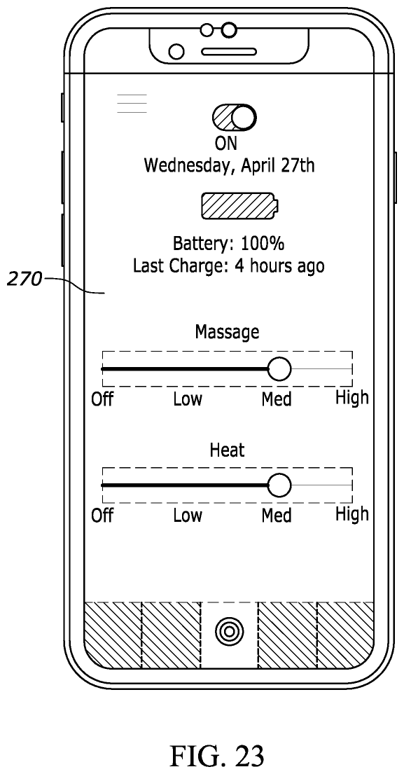

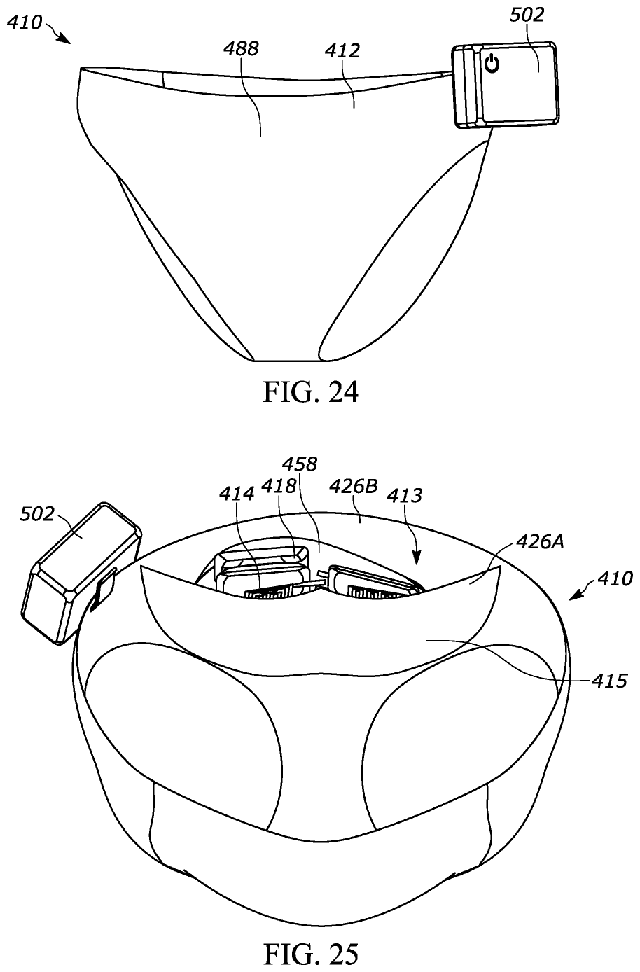

In FIGS. 5 and 6, the back 36 of the wearable device 10 includes a thinner band at the back 36 of the device 10 compared to the body 58. This permits a user to fit the device 10 comfortably over the hips of the user while the body 58 remains in place on the person's body 12. There may be other possible structures of the outer fabric 26 of the device 10, such as but not limited to, a same-width band of fabric all the way around the user's body. In another example, shown and described below with respect to FIGS. 23 and 24, the wearable device may be a garment, such as, for example, an undergarment, which secures the body of the device against an abdominal region of a person's body 12.

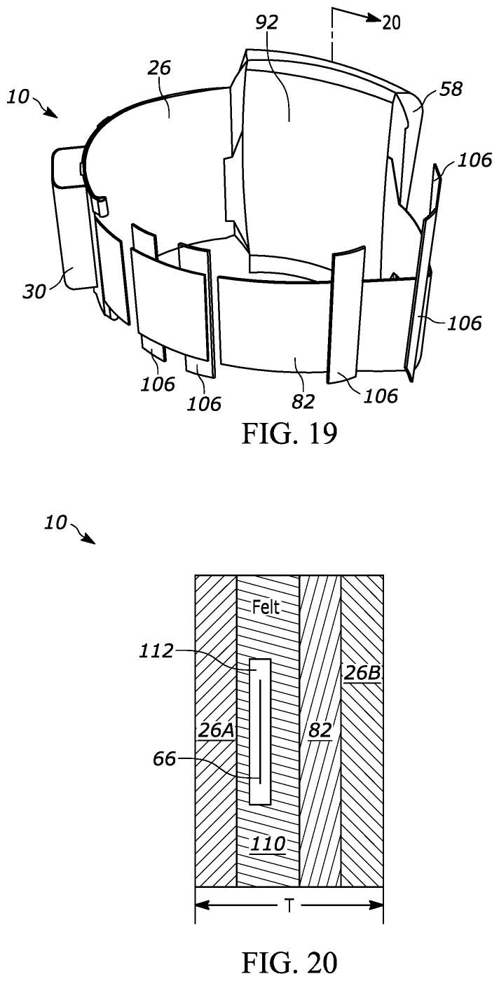

FIG. 7 shows a back perspective view of the wearable device's heating assembly 14. The heating assembly 14 includes a heating element 66 positioned at the interior side 92 and opposite sides 32A, 32B of the wearable device 10 and connected via electrical wiring 67 to the power source 22. The heating elements 66 are arranged to heat up to a therapeutic temperature in order to relax the targeted body part, and in this example, the uterus and lower abdominal muscles to relieve pain caused by dysmenorrhea. In other examples, the heating elements 66 may be placed at different locations on the wearable device 10 to provide comfort to other areas of the body, such as, but not limited to, the lower back and/or hips. In this example, the heating element 66 is coated nichrome heating wire, but other types of resistive heating elements may also be used, such as infrared heating elements, polymide-encased etched foil flexible heating elements, screen-printed heating circuits, cupronickel wire, and/or a combination of these and other heating elements. The heating elements 66 are integrated, embedded, disposed, sandwiched, or stitched into one or more layers of the device 10. In FIG. 7, the nichrome wires 66 are embedded within a fabric layer 110 (FIG. 19) of the body 58. In other examples, the components of the heating assembly 14 and massage assembly 18 may be included within the device 10 in a different location, and the components themselves may also differ.

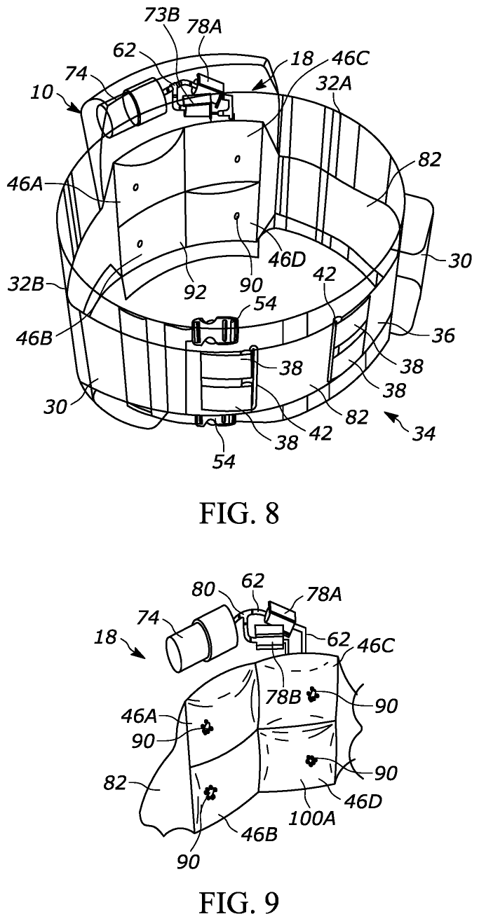

Turning now to FIGS. 4, 8, and 9, the massage assembly 18 is disposed between the first and second layers 26A, 26B of the device 10. In FIGS. 4 and 8, the device 10 is illustrated without the fabric layer 26 to highlight some of the components of the massage assembly 18 disposed adjacent to the exterior side 88 (FIG. 4) and interior side 92 (FIG. 8) of the body 58. In FIG. 4, flexible plastic tubing 62, an air pump 74, and two 3-way solenoid valves 78A, 78B are shown. In FIG. 8, the interior side 92 of the body 58 is depicted to illustrate a plurality of inflatable bladders 46A, 46B, 46C, and 46D (which may be collectively referred to herein as “bladders 46”) of the massage assembly 18.

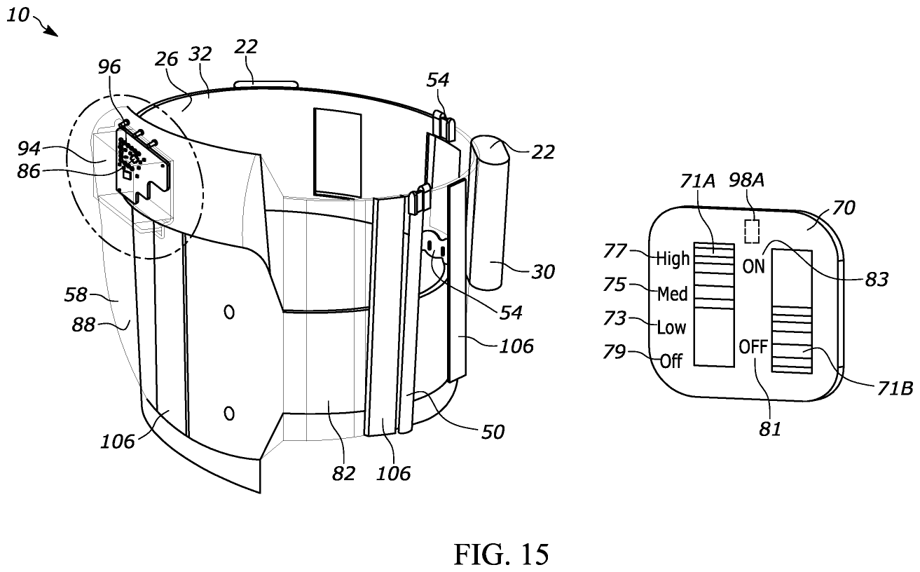

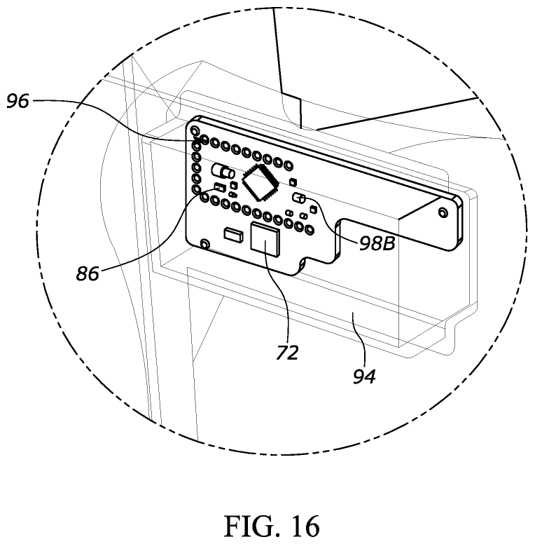

FIG. 9 illustrates the massage assembly 18 including four inflatable rectangular pillow-shaped air bladders 46A, 46B, 46C, and 46D, two three-way solenoid valves 78A, 78B, and one air pump 74. The pump 74 is connected to both solenoid valves 78 using flexible tubing 62, and the two solenoid valves 78A, 78B are connected to two air bladders 46 each using flexible tubing 62. The pump 74 is powered by the battery 22 connected to the device 10. In this example, the pump 74 feeds air through the flexible tubing 62 and solenoid valves 78A, 78B to the air bladders 46 to inflate the bladders 46. To deflate the air bladders 46, a processor 86 (FIGS. 15 and 16) opens an outlet in the solenoid valve 78A, 78B to allow the air to escape. In other embodiments, there could be different types and arrangements of tubing 62, and there could be a different type of pump 74 or means of creating a force into the body of the user, such as a fluid pump or linear actuator. Additionally, different numbers or types of valves 78 can be used to create different patterns and extents of inflation of the multiple bladders 46. In this example, the pump 74 used to inflate the air bladders 46 is positioned above the air bladders 46, but it could also be positioned other places, such as on the side or back of the wearable device 10. Additionally, if air bladders 46 are used, there can be different sizes, shapes, or numbers of air bladders used. All components can be positioned at a different place on the wearable device 10 to target a different area on the user's body 12.

In the specific arrangement in FIGS. 4 and 8, the pump 74 is coupled to the first and second solenoid valves 78A, 78B to inflate and deflate the four bladders 46 in a two-by-two arrangement. The first solenoid valve 78A is connected to, by way of a three-way connector 80A (FIG. 4), a first flexible tubing 62A and a fourth flexible tubing 62D connected to respective first and fourth bladders 46A, 46D. As the first solenoid valve 78A opens and closes, the first and fourth bladders 46A, 46D inflate and deflate together. The second solenoid valve 78B is connected to, by way of a second three-way connector 80B (FIG. 4), a second flexible tubing 62B and a third flexible tubing 62C connected to respective second and third inflatable bladders 46B, 46C to inflate and deflate together. So configured, the first and fourth air bladders 46A, 46D may inflate at a different rhythm and strength than the second and third air bladders 46B, 46C.

In one example, the massage assembly 18 may include two bladders, for example, 46A and 46C each connected respectively to first and solenoid valves 78A, 78B. While the illustrated example depicts the bladders 46 positioned in a 2-by-2 configuration, other configurations are possible. In an example two-bladder massage assembly, the two bladders 46A, 46B may be arranged on top of one another, or a different example two-bladder massage assembly, the two bladders 46A, 46C may be arranged adjacent to one another (as shown in FIG. 8). In another example, the massage assembly 18 may be arranged to coordinate different inflation dynamics, depending on the desired treatment. For example, the first and second bladders 46A, 46B may inflate/deflate together and the third and fourth bladders 46C, 46D may inflate/deflate together; or all bladders 46A-46D may inflate together. In another example, each of the bladders 46 may be coupled to a different solenoid valve for controlling each bladder 46 separately. In yet another example, the massage assembly may include an odd number of bladders, and the bladders may be of differing sizes and shapes.

To apply sufficient massaging force to a user's body 12, the air bladders 46 of the massage assembly 18 are arranged within the device 10 (i.e., between the first and second layers 26A, 26B of the body 58) to press into the user's body. In the example of FIG. 8, the adjustable fabric band 82 is positioned between the second layer 26B of the body and a first surface 100a of the bladders 46. The band 86 extends around the loop of the device 10, and may be adjusted using the closure device 34 in the back 36, tightening the band 82 around the user's body 12 so that the user can increase or decrease the force they feel from the massage. In other words, the air bladders 46 are disposed internally relative to the band 82 and adjacent to the interior side 92 of the body 58. As shown in FIG. 4, the tubing 62 is disposed on the exterior side 88 of the body 58 and extends or traverses through a portion of the band 82 to couple to a second side or surface 100B of the inflatable bladders 46. However, in other examples, the tubing 62 may be arranged on the same side of the band 82 as the air bladders 46 to avoid extending through the band 82. In the example arrangement, the adjustable fabric band 82 is a canvas material with sufficient stiffness. In other examples, the band 82 may be other, such as, for example, a flexible plastic, non-woven fabric, mesh, or a combination of materials. Other means of ensuring the force is directed into the user's body 12 may be used. For example, an adhesive such as a tape larger than the area of the bladder may be placed over the bladder and may also adhere onto the skin or fabric closest to the body.

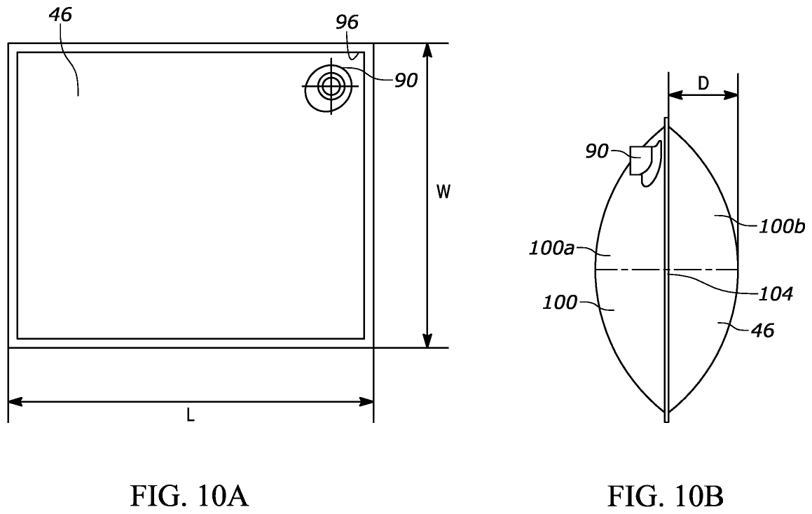

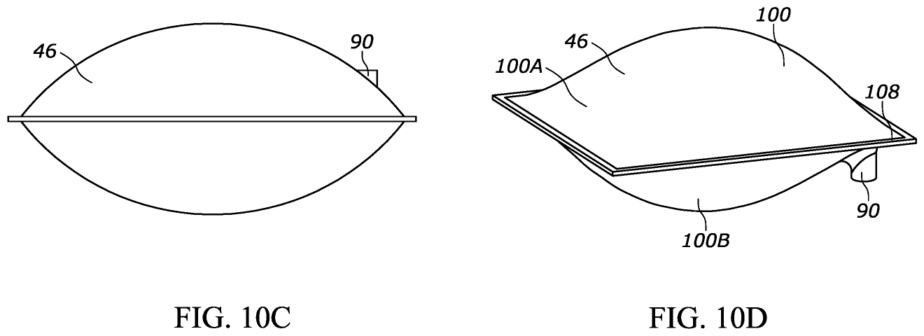

FIGS. 10A, 10B, 10C, and 10D show an example air bladder 46 used in the dynamic massage assembly 18. The air bladder 46 has a first side 100a and a second side 100b attached at a seam 104. When inflated, the bladder 46 forms a rectangular pillow shape. A port 90 for coupling to the flexible tubing 62 is placed on the outside surface 100 of the bladder 46. In this example, the bladder 46 has approximate dimensions of 2 inches by 2.5 inches, but may be sized differently. For example, a length L of the bladder 46 may be in a range of approximately 1.5 inches to approximately 3 inches; in a range of approximately 2 inches to approximately 2.75 inches; and a range of approximately 2.25 inches to approximately 2.5 inches. A width W of the bladder 46 may be in a range of approximately 1 inch to approximately 2.5 inches; in a range of approximately 1.25 inches to approximately 2.25 inches; and in a range of approximately 1.5 inches to approximately 2 inches. Other example dimensions of the bladder 46 may be determined based on a ratio of W/L being in a range of approximately 3/5 to approximately 4/5. The port 90 may be sized to accommodate a different size or type of tubing 62. In another example, the bladder 46 may have integrated tubing and would not include a port. The port 90 shown in FIGS. 10A-10D is placed in proximity to a corner 108 of the air bladder 46, but the tubing port 90 may be placed at any location on the surface 100 of the air bladder 46. FIGS. 10B and 10D show how the bladder 46 will look fully inflated. In FIG. 10B, the bladder 46 is arranged to inflate symmetrically on both sides 100a, 100b and expands from the seam 104 a depth D. The depth D may be in a range of approximately 0.1 inches to approximately 3 inches; in a range of approximately 0.5 inches to approximately 2.5 inches; and in a range of approximately 1 inch to approximately 2 inches. So configured, when the bladder 46 is adjacent to the compression band 82, the inflatable bladder 46 expands away from the body 58 (and into the body 12 of a user) to apply a massaging force. In other examples, the bladder 46 may inflate asymmetrically or in any other configuration. In yet other examples, the air bladder 46 may be a different shape, such as circular.

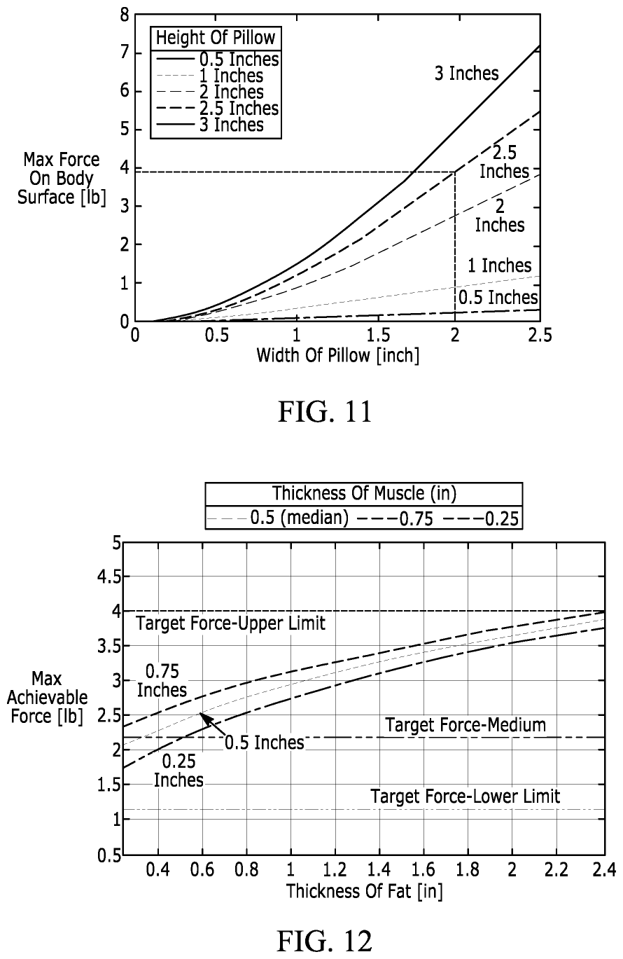

FIG. 11 is an example data plot of the maximum force on the body generated by the dynamic massage assembly 18 for various dimensions of a rectangular pillow-shaped air bladder 46. The x-axis of the graph is the width of the pillow-shaped air bladder 46 in inches, the y-axis of the graph is the maximum force on the body surface in pound-force. Each line on the graph corresponds to a different pillow-shaped air bladder 46 height, where the height of the pillow-shaped air bladder 46 is twice the depth D (as shown in FIG. 10B), or in other words, taken to be a vertical dimension of the bladder 46 when viewed from a plane perpendicular to the axis of inflation. This example data plot shows that for the pillow-shaped air bladder 46 depicted in FIGS. 10A, 10B, 10C, and 10D, the force exerted on the body surface of the user is approximately 4 lbf. The size and shape of the pillow-shaped air bladder 46 may be changed to alter the force exerted on the body of the user. For example, one of more of the bladders 46 of the dynamic massage assembly 18 is arranged to exert a force in a range of approximately one pound to approximately seven pounds; in a range of approximately 2 pounds to approximately 6 pounds; and in a range of approximately 3 points to approximately 5 pounds.

FIG. 12 is an example data plot of the maximum achievable force on the body generated by the dynamic massage assembly 18 varying the user's muscle and body fat thicknesses. The x-axis of the graph is the thickness of fat on the user's lower abdominal area in inches. The y-axis of the graph is the maximum achievable force on the user's body in pound-force. Each line on the graph corresponds to a different muscle thickness on the user's lower abdominal area in inches. The upper force limit, median force limit, and lower force limit are shown on the plot in various dashed lines. Testing showed that the most comfortable massage force was between one and four pounds-force. This data plot shows that using the iteration of the dynamic massage assembly 18 shown in FIG. 9, the most comfortable amount of massage force may be achieved on a wide range of body types and compositions.

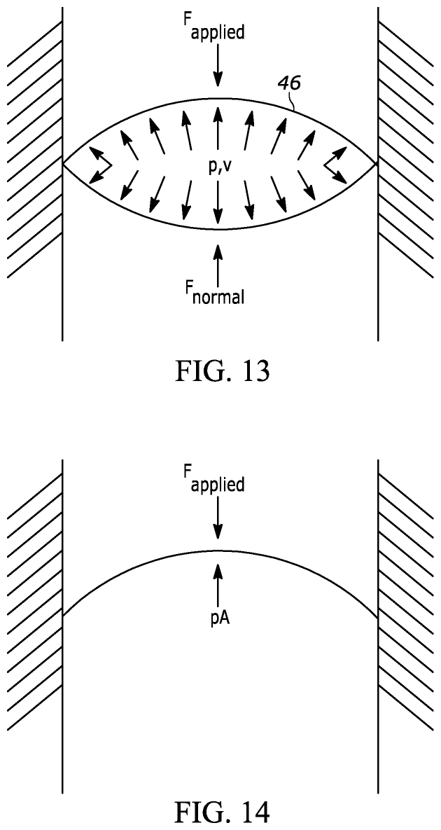

FIGS. 13 and 14 are example force diagrams of the example bladder 46 of FIGS. 10A-10D in a testing scenario demonstrating the mechanism of how inflation applies a massaging force into the body 12. In both figures, a cross sectional view of an inflated bladder 46 is cut directly through its center. The bladder 46 is inflated to some constant volume (V) with an internal pressure (p), and an area (A) is a cross-sectional area of the bladder in the plane perpendicular to the applied force. FIG. 13 depicts an example test setup in which a force is applied (F_{applied}) vertically downward onto the center of a single bladder perpendicular to the full area (A) of one half of the bladder. The bladder is resting on a hard flat surface, represented by the upward normal force (Fₙₒᵣₘₐₗ), and is pinned at its sides such that it cannot move horizontally. F_{applied} and Fₙₒᵣₘₐₗ are equal and opposite forces which cause the inflated bladder to be in static equilibrium. Because the two forces are of equal magnitude, the bladder 46 is symmetrical about its horizontal center axis, so it is assumed the effect of the forces on both the bottom and top sheets of the bladder 46 are the same.

FIG. 14 depicts the effect of the force on the top sheet of the bladder 46 and demonstrates how that applied force directly relates to the variable pressure within the bladder 46. This example test scenario is analogous to how the bladder 46 will apply a massaging force into the body 12. The normal force provided by a hard testing surface (such as, for example, a table) is similar to the normal force on the bladders 46 provided by the example constricting fabric strap 82 in FIG. 8. By inflating the bladder 46 to some volume, that force can be transmitted to and felt on the body as the applied force. This example of how the force can be transmitted to the body is applicable to other forms of expanding volumes, such as but not limited to, other fluid filled volumes or linear actuators.

In FIG. 15, the device 10 includes a control system 96 and remote communication device 70 that is used to control and/or monitor the heating and massage assemblies 14, 18 of the wearable dynamic massage device 10. The remote communication device 70 may be programmed to turn the entire system (i.e., both heating and massage assemblies 14, 18) on and off, turn heating components and massage components on and off independently, and/or modulate the strength and frequency of the massage components. In this example, the remote communication device 70 communicates with the massage device 10 wirelessly, but in other examples, the device 10 may be controlled with wired communication or other communication method. In this example, the remote communication device 70 can clip onto the massage device 10 or the user's clothing.

FIGS. 15 and 16 show perspective, partially transparent views of an example control system 96. The control system 96 is coupled to the massage assembly 18 to selectively operate the first and second solenoid valves 78A, 78B to inflate one or more of the bladders 46. The control system 96 is housed in a box 94 between the first and second layers 26A, 26B of the body 58 of the device 10. The processor 86 illustrated in FIG. 16, and its function includes, but is not limited to receiving user input from a separate controller indicating one or more operational parameters for controlling the device 10. For example such operational parameters may include turning on and off the separate massage assembly 18 and heating assembly 14, controlling the intensity and periods of the different assemblies 14, 18, monitoring battery 22 and device 10 health and safety, and tracking usage. The processor 86 is located in the same casing 94 as the pump 74 and valves 78. However, in other examples the processor 86 may be placed at different locations on the wearable device 10. The processor 86 is powered by the same batteries 22 that power the device 10, but the processor 86 could also have an independent power source.

In the illustrated example, the separate controller is a remote communication device 70. However, in other examples, the separate controller may be a different remote communication device such as, for example, a smartphone application. In this example, the remote communication device 70 that collects the user input takes the form of a handheld electronic remote 70 that communicates with the processor 86 of the control system 96 via a short range wireless communication link, such as a Bluetooth signal. In other iterations of the device 10, the remote communication device 70 may take a different form, such as, but not limited to, buttons or switches attached to the device, buttons, switches or a graphic interface on a remote control, smartphone app, or other computing device.

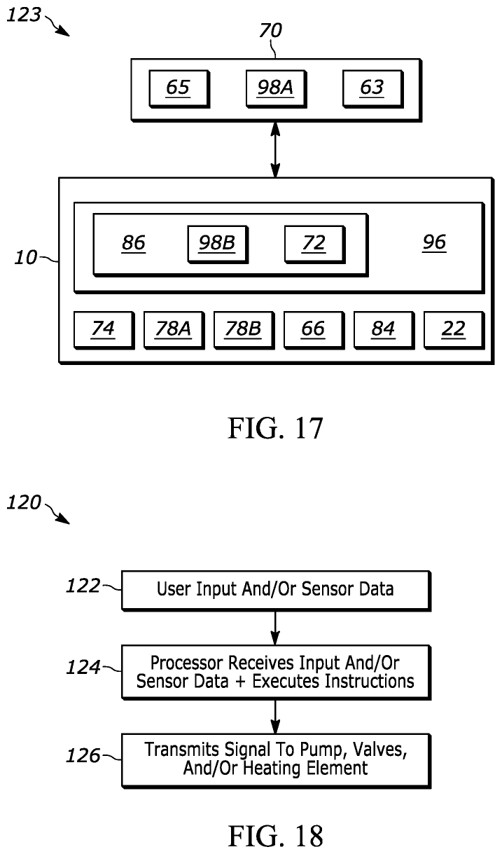

The capabilities of the communication system 123 is shown in FIG. 17. The remote communication device 70 is seen on the top of the image and includes a powered microcontroller 98A, a user interface 65, which may be a touch-screen or, an on-off switch as shown in FIG. 15, and a memory 63. When the user inputs a desired operational parameter via the remote 70 (e.g., the switches 71A, 71B are activated in one or more modes by sliding the switches 71A, 71B along a track), the remote communication device 70 communicates (e.g., via a Bluetooth signal) with the processor 86 of the control system 96 of the device 10. The processor 86 includes a second powered microcontroller 98B and a memory 72. When the processor 86 receives the signal from the remote communication device 70, the processor 86 communicates with the pump 74, valves 78A, 78B, and/or sensors 84.

An example method 120 of communication of the remote communication device 70 and the control system 96 to operate the device 10 is shown in FIG. 18. First, at step 122, a user inputs to the remote communication device 70 desired massage and/or heat preferences. This control may be done on the user interface 65 via discrete options on the remote communication device 70 or by more variable methods, such as on a phone app, and be stored in a memory 72 of the processor 86, memory 63 of the remote communication device 70, control system 96, and/or or any other memory storage method. In this example, the user can control a plurality of different inflation modes (e.g., low 73, medium 75, high 77, off 79) for the massage assembly 18 and power on 81 or off 83 the heating assembly 14. In other examples, a user may be able to control different levels of intensity, periodicity, or power level of the different assemblies or of the device 10 as a whole. For example, the user may turn on the massage assembly 18 by moving the switch 71A to the “low” mode 73, and turn on the heating assembly 14 by moving the switch 71B to “on” 83 using the controller 70. The controller 70 communicates this user input with the processor 86. Also at step 122, sensor data collected from sensors 84 on the device 10 may be communicated to the processor 86 of the device 10. For example, if the sensors 84 identify that the heating element 66 exceeds a threshold temperature, the sensors 84 transmit this information to the processor 86.

Once the user has input this data and/or the sensors 84 collected data, this data is transmitted to the processor 86 of the device 10. At step 124, the processor 86 receives user input data and/or sensor data, and communicates with the memory 72 and/or microcontroller 98B to execute instructions stored on the memory 72. The processor 86 executes the instructions on the memory 72 to perform one or more operational parameters of the massage and heating assemblies 14, 18 (e.g., speed of inflation, inflation level, massage intensity, temperature, etc.). In this example, data is communicated via a wireless communication link, such as a Bluetooth signal, but it could also be communicated by other channels, such as, but not limited to, Wi-Fi, RFID, NFC, other wireless communications, or direct connection of electronics wiring or cables. For example, the processor 86 executes instructions on the memory 72 to operate the massage assembly 18 at a pre-programmed “low” setting, which may include speed, inflation, and other controllable characteristics of the bladders 46.

When the instructions are executed by the processor 86, at step 126, the processor 86 transmits signals to the other components, such as, but not limited to, the valves 78A, 78B, pump 74, batteries 22, and heating components 66. The processor 86 uses these signals to control and manipulate the effect of the massage assembly 18 and heating assembly 14 on the body. For example, at step 126 the processor 86 may send a signal to the pump 74 to turn on, and a signal to one or more valves 78A, 78B to open and close at a stored setting. Alternatively, or simultaneously, at step 126, the processor 86 sends a signal to turn on the heating components 66 of the heating assembly 14. At step 122, the processor 86 may receive sensor data associated with the heating assembly 14 so that at step 126, the processor 86 executes instructions and signals to the heating assembly 14 to turn off the heating assembly 14 based on the sensor data.

To control the intensity of the massage assembly 18, the processor 86 sends one or more signals to the valves 78A, 78B and pump 74 to allow the pump 74 to inflate the bladders 46 for longer periods, corresponding to a more forceful massage, or shorter periods, corresponding to a less forceful massage. To control the length of the inflation cycle, the processor 86 sends another signal to the valves 78A, 78B and pump 74 to keep the bladder or set of bladders 46 inflated for a shorter or longer amount of time before they deflate and before the next bladder or set of bladders 46 is allowed to inflate. Another way for the processor 86 to control the dynamic massage would be to send signals to only certain valves 78A, 78B and bladders 46 so that the user can control and target which bladders 46 and areas of the body 12 are massaged. These settings may be controlled by discrete, pre-set options on the remote communication device 70 (e.g., low 73, medium 75, high 77) or by more variable, customizable options on the remote communication device 70. The dynamic massage could also be customized or manipulated in other ways and is not limited to the methods mentioned above.

The heating assembly 14 can also be manipulated and customized by signals sent from the processor 86. For example, like the massage assembly 18, the heating assembly 14 can be carried out in cycles of heated and not heated time periods, controlled by signals from the processor 86. The intensity and temperature of the heat may also be controlled by signals from the processor 86 working with sensors 84 on the device 10 to monitor and maintain a specific temperature. These mechanisms allow a user to choose the timing and temperature of the heating assembly 14 through the remote communication device 70 and the processor 86. These settings may be controlled by discrete, pre-set options on the remote communication device 70 or by more variable, customizable options on the remote communication device 70. The variable heating of the device 10 could also be customized and manipulated in other ways and is not limited to the methods mentioned above. In one example, shown in FIG. 23, the intensity of both heat and massage may be controlled using a touch-screen to more specifically achieve a desired massage intensity and/or heat.

Apart from monitoring the temperature of the heat, the control system 96 of the device 10 may include one or more other sensors 84. Such sensors can also communicate and work with the processor 86 (e.g., at step 122) to monitor the function, health, and safety of the different components of the device 10 (i.e., the heating and massage assemblies 14, 18, battery 22) as well as transmit signals back to the user, for example via an indication light or message via the user interface 65. For example, sensors in communication with the control system 96 may be located at various parts of the device 10 such as, for example, on an internal side of the device 10 to measure heat output experienced by the user, or on or near the bladders 46 to measure inflation forces and rates.

FIG. 19 shows an example band of fabric 82 which is used to retain the air bladders 46 in place against a user's body 12. The band 82 ensures that the massage is focused on a targeted area of the user's body 12 (e.g., lower abdomen, lower back, etc.). This band 82 is positioned within the outer fabric sleeve 26 and is positioned in front of the air bladders 46. In other embodiments, other means of securing the air bladders 46 or other massage assemblies in place may be used. The vertical supports 106 ensure that the fabric outer sleeve 26 does not bunch up and displace the air bladders 46 or other massage assembly 18 components. In this example, there are ten supports 106 in total, five on the right side of the device 10 and five supports 106 on the left side. The vertical supports 106 can be made of a variety of materials and can be placed at different places in the wearable device 10. The vertical supports 106 can also be omitted or changed in number, size, shape, or dimension.

A model was used for heat transfer analysis to determine a heating element 66 temperature that is both safe and effective. This model also shows one possible example of material usage and order of the wearable device 10. The model, shown in FIG. 20, is an example cross-sectional view of layers of the wearable device 10. From left to right, a portion of the body 10 includes a layer of a moisture wicking material 26A, a layer of insulation material 110 such as felt, the heating element 66 coated in polyolefin 112 and embedded in the felt layer 110, the stiffening band 82 to keep the massage assembly 18 in place, and another layer of moisture wicking material 26B. The order of these materials as well as the materials themselves and the thicknesses of the materials may be changed in other embodiments of the device 10. However, a thickness T measured from outermost surfaces of the body portion is in a range of approximately 0.2 inches to approximately 2.5 inches.

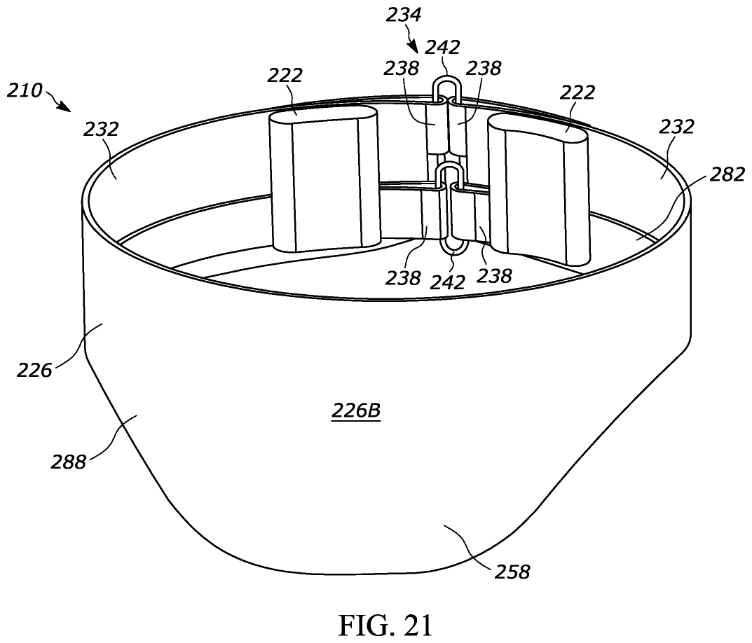

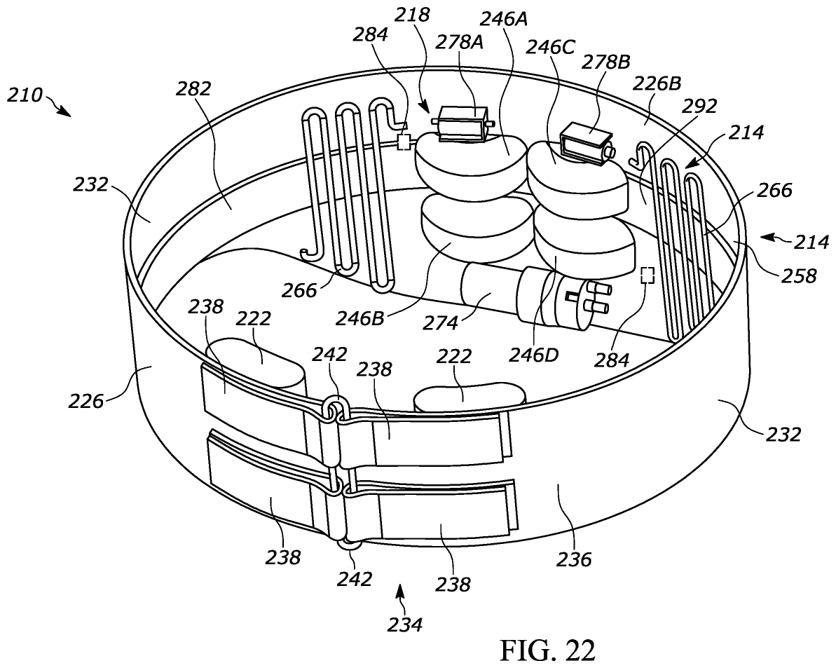

In FIGS. 21 and 22, a second example wearable device 210 is assembled in accordance with the teachings of the present disclosure. The wearable device 210 is similar to the device 10 described above, except that the second example wearable device 210 includes variations in closure assembly 234, heating assembly 214, and massage assembly 218. Elements of the device 210 in FIGS. 21 and 22 that are similar to the elements of the device 10 are designated by the same reference numeral, incremented by 200. A description of many of these elements is abbreviated or even eliminated in the interest of brevity.

The closure assembly 234 of the device 210 includes four hook and loop straps 238 at a center back 236 of the device 210. Each strap 238 is pulled through an oval-shaped ring 242, positioned with a longer side oriented vertically (relative to the orientation of the device 210 in FIGS. 21 and 22), then fastened to an outer side of a fabric outer sleeve 226 of the wearable device 210. The heating assembly 214 includes heating elements 266 placed adjacent to the body 258 of the device 210, immediately to either side of the air bladder array 246. The massage assembly 218 includes four air bladders 246A, 246B, 246C, 246D internally positioned relative to a first layer 226B of a body 258 a stiffer fabric inner band 282. The body 258 may include a second layer (not shown for illustrative purposes) disposed between a user's body and the heating and massage assemblies 214, 218. The power source 222 includes two batteries 222 positioned on either side of the center back closure 234, and power the entire device 210, including the heating assembly 214 and the massage assembly 218.

In the illustrated example, the air bladders 246 include a half-cylinder shape split along a plane coincident with a central axis of the bladder array 246. The air bladders 246 are inflated by a pump 274 which is located below the four air bladders 246. In this example, two three-way solenoid valves 278A, 278B, which are located above the air bladders 246, one on the right and one on the left, are used to inflate and deflate the air bladders 246. A different shape or number of air bladders and a different number or type of valves may be used instead. Additionally, valves 278A, 278B may be replaced by a different means of massaging the abdomen without the aid of valves. While a network of flexible tubing coupling the bladders 246, the valves 278A, 278B, and the pump 274 are hidden, the illustrated example may incorporate tubing similar to the tubing 62 of the first example device 10.

The wearable device 210 can be controlled using a wired or wireless controller, according to diagram and schematic of FIGS. 17 and 18, or a remote communication device, such as illustrated and described with respect to FIGS. 15-18. One example of a wireless controller is a smartphone app 270 shown in FIG. 23. In this example, the user can turn the device 210 on or off using the app 270 as well control the heat and massage settings independently and monitor the battery life of the wearable device 210. This is one possible iteration of an app-based controller, and a controller may monitor different or additional metrics as well as those listed above, such as allowing the user to monitor usage of the device, or give reminders of when in the user's menstrual cycle they are likely to benefit from using the wearable 210. The smartphone app 270 may also be arranged to work with the wearable device 10 of FIGS. 1-16, and in a similar manner as shown and described in FIGS. 17 and 18.

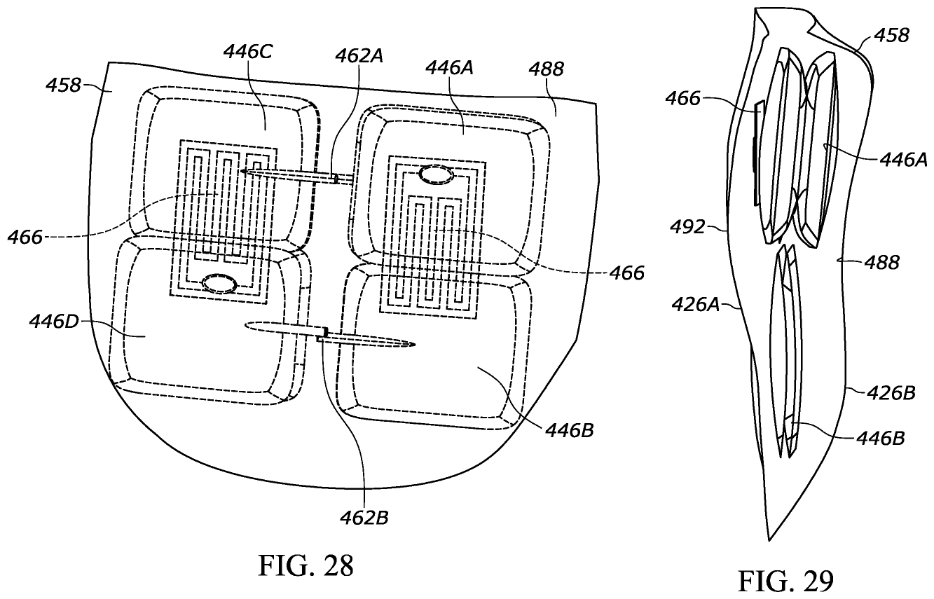

In FIGS. 24-32, a third example wearable device 410 for treating abdominal pain is assembled in accordance with the teachings of the present disclosure. The wearable device 410 is similar to the devices 10 and 210 described above, except that the third example wearable device 410 includes a garment 412, such as an undergarment, and a separable body 258 or insert that is removably coupled to the garment 412. Additionally, a control system 496 of the device 410 is also different. However, elements of the device 410 in FIGS. 24-32 that are similar to the elements of the device 210 are designated by the same reference numeral, incremented by 200. A description of many of these elements is abbreviated or even eliminated in the interest of brevity.

The wearable device 410 includes the undergarment 412 defining a pocket 413 that receives the body 458. The body 458 houses the heating and massage assemblies 414, 418 and is insertable into the pocket 413 of the undergarment 412 for use. The undergarment 412 may be a range of different types of undergarments, such as panties, underwear, briefs, or other types of garments such as pants or shorts. The insert 458 is removable from the garment 412 to wash the garment or if the massage and heating assemblies 414, 418 are not needed by the user. The control system 496 is coupled to the heating and massage assemblies 414, 418, and communicates with a remote controller, such as the smartphone app shown in FIG. 23, to operate the device 410. As will be described below, the control system 496 includes a housing 494 protecting the internal components (e.g., pump, valves, battery, processor, memory, microcontroller, etc.), and includes ports to electrically couple the control system 496 to the heating and massage assemblies 414, 418.

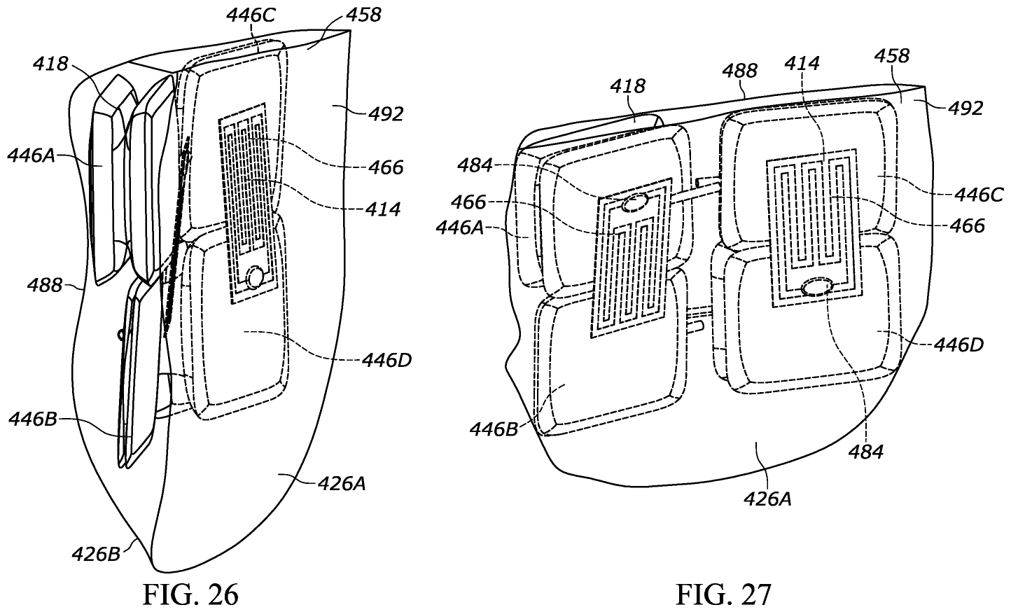

In FIGS. 26-29, the portable body or insert 458 is illustrated. The body 458 includes a first layer 426A defining an interior side 492 and a second layer 426B defining an exterior side 488 of the body 458. One or more of the inflatable bladders 446 of the massage assembly 418 is attached to an internal surface of the second layer 426B of the body 458 to secure the bladder array 446 in place. The compression is created simply by choosing an elastic material for the undergarment 413. The heating assembly 414 includes one or more flexible heating elements 466 that are attached to an internal surface of the first layer 426A of the body 458 to secure the heating elements 466 in place. In the illustrated example, the heating elements 466 are polyimide-encased etched foil flexible resistive heating elements, which are lightweight, thin, and flexible. For best heat transfer to a user, the interior side 492 of the insert 458 is placed adjacent to a pocket layer 415 of the undergarment 413. In other words, the body 458 may be oriented such that the heating elements 466 face a user's body. However, in other examples, the insert 458 may not include a heating element 466, and instead only provide dynamic massage.

The heating and massage assemblies 414, 418 are fixed to the first and second layers 426A, 426B of the body 458 to avoid the components of the assemblies 414, 418 moving relative to the body 458. The assemblies 414, 418 may be attached to one or more of the first and second layers 426A, 426B using adhesive, heat sealing, RF sealing, or other methods. In contrast to the first and second layers 26A, 26B of the body 10 of the first example wearable device 10, the first and second layers 426A, 426B are made from a thin, flexible, plastic sheeting. However, in other examples, the first and second layers 426A, 426B may be a woven or non-woven fabric or other material.

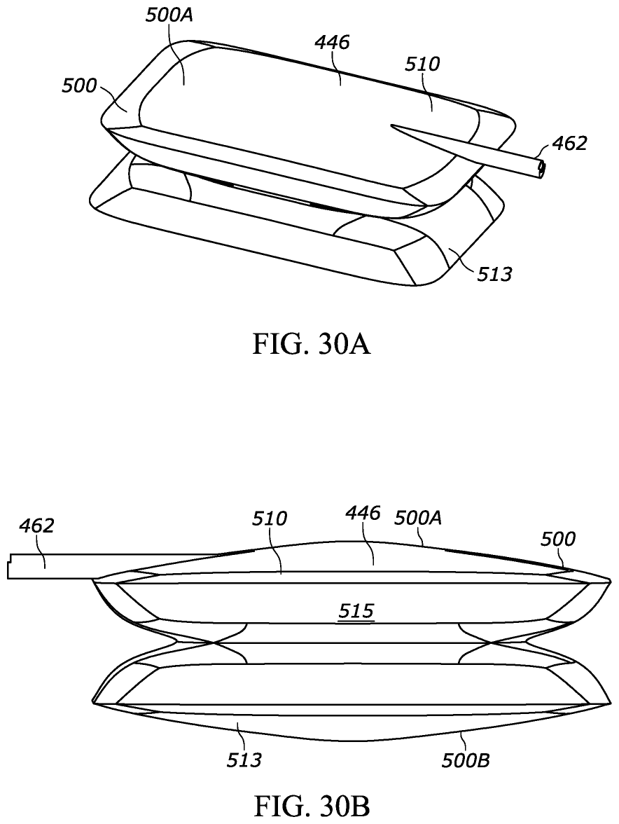

FIGS. 30A and 30B show an example air bladder 446 used in the dynamic massage assembly 418. The bladder 446 includes an integrated double-cushion shape including a first cushion 510, a second cushion 513, and a tubing 462 in fluid communication with an interior volume 515 of the bladder 446. As shown in the cross-sectional view in FIG. 30B, the first and second cushions 510, 513 both define the interior volume 515. The flexible tubing 462 is integrally formed with an outer surface 500A of the first cushion 510. However, in other examples, the bladder 446 may have a port, such as the port 90 of the bladder 46 in FIGS. 10A-10D. The flexible tubing 462 is arranged to connect with a connector and/or other flexible tubing to connect with the pump and valves of the massage assembly 418. A network of flexible tubing and connectors similar to the network of tubing in FIG. 4 may be used to connect the bladders 446 to the pump 474 in the electronics module 502. As shown in FIG. 29, the first bladder 446A is inflated and the second bladder 446B is deflated. In this example, the first and second bladders 446A, 446B are coupled to different solenoid valves as they inflate and deflate independently. However, in other configurations of the massage assembly 418, the first and second bladders 446A, 446B may be arranged to inflate and deflate together.

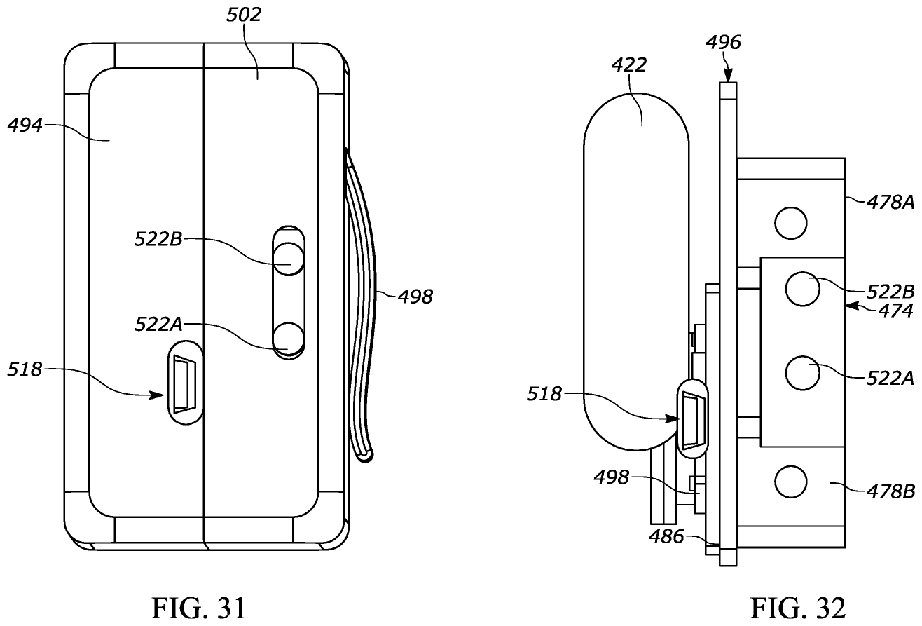

FIGS. 31 and 32 illustrate an electronics module 502 of the wearable device 410. The electronics module 502 provides both communication capabilities between a remote controller (e.g., the smartphone app of FIG. 23) and a control system 496 of the device 410, as well as supply power and pumping functionalities to the massage and/or heating assemblies 414, 418 when coupled to the body 458. A control system 496, which includes a processor 486, memory, and a microcontroller 498, a battery 422, a first solenoid valve 478A, a second solenoid valve 478B, and a pump 474 are housed in a rigid housing 494 of the electronics module 502. The housing 494 optionally includes a clip 498 arranged to couple the control system 496 to the garment 413 or other article of clothing worn by the user. A charging port 518 and first and second tubing outlets 522A, 522B of the pump 474 are positioned on a side of the housing 494. However, in other examples, the charging port 518 and the tubing outlet 522A, 522B may be positioned together on a different side of the housing 494, or positioned separately on different sides of the housing 494. The charging port 518 is electrically coupled to the battery 422 and is arranged to charge the battery 422 when coupled to a power source. However, in other examples, the rechargeable battery 422 may instead be a disposable battery. In yet another example, one or more of the battery, control system, pump, and valves may be disposed on or near the body 458 of the device 10. In some examples, the electronics module 502 may also include a user interface, such as a touchscreen, and/or LEDs or other lights used to display messages to the user such as, for example, low battery life, status of the heating assembly 414 (e.g., on or off), and/or status of the massage assembly 418 (e.g., on, off, and desired mode).

While the present disclosure describes and discusses various wearable massage devices 10, 210, 410 having different features, it is contemplated that the different features can be combined in any manner or fashion to achieve desired results. For example, the present disclosure contemplates that the device in FIGS. 1-9, 15-20 can be modified to include any or all of the features of any of FIGS. 21-32 and/or elsewhere discussed herein. The present disclosure contemplates that the device in FIGS. 21-23 can be modified to include any or all of the features of any of FIGS. 1-9, 15-20, and 24-32 and/or elsewhere discussed herein. The present disclosure contemplates that the device in FIGS. 24-32 can be modified to include any or all of the features of any of FIGS. 1-9, 15-23 and/or elsewhere discussed herein. Further, the present disclosure contemplates that the experimentation and results shown in FIGS. 11-14 may apply to determining the specifications of various components of the devices 210 and 410 of FIGS. 24-32. This includes, but is not limited to, combining the various wearable devices 10, 210, 410 with the various remote controllers 70, 270, and/or communication system 123 (e.g., FIG. 17) to perform the method 120 of FIG. 18. In other words, the remote controller 70 or smartphone app 270 of the first and second example devices 10, 210 may also be used to operate and control the device 410 of FIGS. 24-32. Accordingly, FIG. 17 also represents an example block diagram of communications between a remote controller and the device 410, and FIG. 18 also represents an example method of operating the device 410. Thus, while the following features can be considered as independent alternatives, they can also be complementary features, in that any heating and massage pair within the scope of the present disclosure can include any combination of features taken from FIGS. 3-10 and/or elsewhere discussed herein.

The first, second, and third example wearable massage device 10, 210, 410 as disclosed herein provide numerous advantages for treating pain. Each of the wearable devices permits a user to discreetly conceal and operate the device under the user's clothing to provide pain relief, thereby allowing the user to receive massage and/or heat therapy while participating in daily activities.

The devices are also configured for treating abdominal or back pain of any body type. The bladder arrays 46, 246, 446 of the massage assemblies 18, 218, 418 are arranged to inflate and expand into the user's body to create a gentle massaging or “kneading” feeling on the user's lower abdominal area. The data plot of FIG. 12 shows that the dynamic massage assemblies 18, 218, 418 of each device 10, 210, 410 may achieve the most comfortable amount of massage force on a wide range of body types and compositions. Additionally, the devices 10 and 210 include adjustable straps that can be adjusted for hip and waist size, and the third device 410 is paired with one or more garments selected by, and sized for, the user.

Each device 10, 210, 410 may be programmed and/or operated to direct a desired combination of heat treatment and dynamic massage to treat pain on any user. In some examples, the heat assembly may be excluded from the device or may be deactivated, as needed. The user has a range of selections for customizing their treatment including, for example, selecting a temperature, pulsing heat, intensity and duration of massage. In some examples, the memory may store programmed therapies (both heat and massage) based on a user's preference. Also the remote controller may be programmed by a user to store favorite configurations and therapies.

Finally, although certain wearable massage devices 10, 210, 410 have been described herein in accordance with the teachings of the present disclosure, the scope of coverage of this patent is not limited thereto. On the contrary, while the disclosed devices 10, 210, 410 have been shown and described in connection with various examples, it is apparent that certain changes and modifications, in addition to those mentioned above, may be made. This patent application covers all examples of the teachings of the disclosure that fairly fall within the scope of permissible equivalents. Accordingly, it is the intention to protect all variations and modifications that may occur to one of ordinary skill in the art.

What is claimed:

1. A massage device comprising:
a body including a first layer defining an interior side and a second layer defining an exterior side;
a heating assembly including a heating element disposed adjacent to the interior side of the body;
a massage assembly including a pump and an inflatable bladder coupled to the pump, the massage assembly coupled to the body and arranged to provide a dynamic massage;
a power supply electrically couplable to the heating assembly and the massage assembly.

2. The massage device of claim 1, wherein the massage assembly includes a second bladder coupled to the pump.

3. The massage device of claim 2, wherein the bladder is coupled to a first solenoid valve and the second bladder is coupled to a second solenoid valve, the first and second solenoid valves are coupled to the pump.

4. The massage device of claim 3, wherein the massage assembly includes a third bladder coupled to the first solenoid valve.

5. The massage device of claim 3, further comprising a control system coupled to the massage assembly to selectively operate the first solenoid valve and the second solenoid valve to inflate one or more of the bladders.

6. The massage device of claim 5, wherein the control system includes:
a processor;
a memory communicatively coupled to the processor and storing executable instructions that, when executed by the processor, causes the processor to:
receive data transmitted by a remote communication device;
send a signal to one or more of the first and second solenoid valves to open, thereby inflating the one or more bladders based on the data received.

7. The massage device of claim 6, wherein the control system is coupled to the heating assembly and wherein the instructions, when executed by the processor, causes the processor to control the heating assembly by activating the heating element of the heating assembly based on the data received.

8. The massage device of claim 1, wherein the massage assembly is disposed between the first layer and the second layer of the body.

9. The massage device of claim 8, further comprising a garment defining a pocket sized to receive the body, the body being insertable in the pocket of the garment.

10. The massage device of claim 9, wherein the body has a width of less than two inches.

11. The massage device of claim 1, wherein the body includes a fabric layer, the heating element of the heating assembly being embedded in the fabric layer.

12. The massage device of claim 1, wherein the body includes a material layer adjacent to the massage assembly so that the bladder expands away from the second layer of the body when the bladder is inflated.

13. The massage device of claim 1, wherein the massage assembly is configured for providing a force in a range of approximately one pound to approximately five pounds.

14. The massage device of claim 1, further comprising an adjustable strap attached to a first side and a second side of the body, the flexible strap arranged to form a loop with the body.

15. A wearable massage device comprising:
a body having first layer and a second layer coupled to the first layer, the body configured for placement on a person;
a massage assembly at least partially disposed between the first and second layers of the body, the massage assembly including a pump, a first inflatable bladder, and a second inflatable bladder, the pump being selectively couplable with one or more of the first and second inflatable bladders to dynamically inflate the first and second inflatable bladders.

16. The wearable massage device of claim 15, wherein the massage assembly includes a first solenoid valve coupled to the first inflatable bladder and a second solenoid valve coupled to the second inflatable bladder.

17. The wearable massage device of claim 16, further comprising a control system operatively coupled to the massage assembly, the control system including:
a processor;
a memory communicatively coupled to the processor and storing executable instructions that, when executed by the processor, cause the processor to:
receive, from a mobile device, via a wireless communication link between the wearable massage device and the mobile computing device, a signal including an indication of one or more operational parameters for controlling the wearable massage device;
control the wearable massage device based on the one or more operational parameters.

18. The wearable massage device of claim 17, wherein the instructions, when executed by the processor, cause the processor to control one or more of an inflation level of one or more of the bladders of the massage device and a speed of inflation of the one or more bladders by causing one or more of the first and second solenoid valves to open, thereby inflating the one or more bladders based on the one or more operational parameters.

19. The wearable massage device of claim 17, further comprising a heating assembly including a heating element coupled to the body.

20. The wearable massage device of claim 19, wherein the heating assembly is operatively coupled to the control system, and wherein the instructions, when executed by the processor, cause the processor to control a heat level of the heating wire of the heating assembly by causing the heating assembly to activate based on the one or more operational parameters.
